(19) United States
(12) Patent Application Publication
(10) Pub. No.: US 2004/0143544 A1
(43) Pub. Date: Jul. 22, 2004

(54) Account management system and method for transferring sums of money and bonus points between account memories in an account management system

(76) Inventors: Manfred Lilge, Berlin (DE); Thomas Ryll, Berlin (DE)

Correspondence Address: MORRISON & FOERSTER LLP, 1650 TYSONS BOULEVARD, SUITE 300, MCLEAN, VA, 22102, US

(21) Appl. No.: 10/645,854

(22) Filed: Aug. 22, 2003

(30) Foreign Application Priority Data
Aug. 23, 2002 (DE) 10238795.8

(51) Int. Cl. G06F 17/60

(52) U.S. Cl. 705/39

(57) ABSTRACT

A method for transferring sums of money and bonus points between account memories in an account management system, in which the account management system, upon receiving a payment request, transfers a sum of money requested by a merchant from a first account memory for storing information about monetary means belonging to a consumer to a second account memory for storing information about monetary means belonging to a merchant, and transfers a number of bonus points from a fourth account memory for storing information about bonus points belonging to the merchant to a third account memory for storing information about bonus points belonging to the consumer. The invention also relates to an account management system.

### CLAIM FOR PRIORITY

This application claims priority to German application 10238795.8 which was filed in the German language on Aug. 23, 2002, which is hereby incorporated by reference.

### TECHNICAL FIELD OF THE INVENTION

The invention relates to an account management system and a method for transferring sums of money and bonus points between account memories in an account management system.

### BACKGROUND OF THE INVENTION

Generally, a purchase operation involves three different groups of participants (roles):

A merchant is a provider of a service or a product for which he demands remuneration.

A consumer is a purchaser of a provided service and needs to pay for it.

A payment service provider (PSP) handles payments between merchants and consumers.

In the conventional world of telecommunications, the network operator appears both as a merchant and as a payment service provider. It provides its consumers with telephone services and bills for these using its existing billing systems (postpaid or prepaid).

With the opening of telecommunication networks (e.g. using Parlay/OSA technology) and also within public data networks (e.g. Internet), third parties are also appearing as merchants providing their own services (e.g. content providers, online shops); these third parties normally do not have their own billing systems, however.

The introduction of “loyalty programs”, in which an end consumer can collect bonus points from a merchant/a group of merchants, has become established in the real world and also in electronic payment operations and is in a wide variety of forms. Examples which may be mentioned are:

Loyalty program from a merchant: consumer card from the retailer “Karstadt”,

Loyalty program from a superordinate provider, “Payback” from “Loyalty Partner Gesellschaft fur Kundenbindungssysteme mbH in München”,

Loyalty program from a PSP: “UBS Key Club”,

Mixed combinations: “Lufthansa miles&more”, where Lufthansa appears once as a merchant and sells air services but also appears as a superordinate partner incorporating points from another merchant (e.g. from the hotel chains “Holiday Inn”) into its program.

Points are normally distributed in a loyalty program following a transaction which has been performed (excluding exceptions such as “welcome points”, that is to say after the merchant and the consumer have done business).

Examples of this which will be mentioned are as follows:

1) The points for the loyalty program are calculated directly from the number of transactions between the consumer and the merchant/merchant group.

2) The points for the loyalty program depend on the level of the transaction, i.e. there is a percentage connection. It is also possible to use a graduated concept, in which a higher percentage is used after threshold values have been reached.

The programs have the drawback/problem that loyalty points (bonus points) are not calculated in real time and the points acquired are thus not available directly for further use. The calculation is performed using “postprocessing”.

The invention provides an improvement in this context and discloses the following method and the following account management system:

In one embodiment, there is an account management system having a first account memory for storing information about monetary means belonging to a consumer, a second account memory for storing information about monetary means belonging to a merchant, a third account memory for storing information about bonus points belonging to the consumer, a fourth account memory for storing information about bonus points belonging to the merchant, and a control unit which, when a payment operation appears, prompts a sum of money to be transferred from the first account memory to the second account memory and prompts a number of bonus points to be transferred from the fourth account memory to the third account memory.

In another embodiment, there is a method for transferring sums of money and bonus points between account memories in an account management system, in which the account management system, upon receiving a payment request, transfers a sum of money requested by a merchant from a first account memory for storing information about monetary means belonging to a consumer to a second account memory for storing information about monetary means belonging to a merchant, and transfers a number of bonus points from a fourth account memory for storing information about bonus points belonging to the merchant to a third account memory for storing information about bonus points belonging to the consumer.

“Loyalty programs” are implemented in real time. The necessary calculations are performed in real time, that is to say when the consumer pays. The parities involved can further use the bonus points (loyalty points) calculated in this manner directly and not only after later calculations by postprocessing systems.

The introduction of “loyalty programs” becomes possible using an e-payment-based solution. The calculations are performed in real time and without any noticeable delays for the parties involved.

### BRIEF DESCRIPTION OF THE DRAWINGS

The description is described below in detail with reference to the drawings, in which:

FIG. 1 shows an exemplary embodiment of the account management system and method.

### DETAILED DESCRIPTION OF THE INVENTION

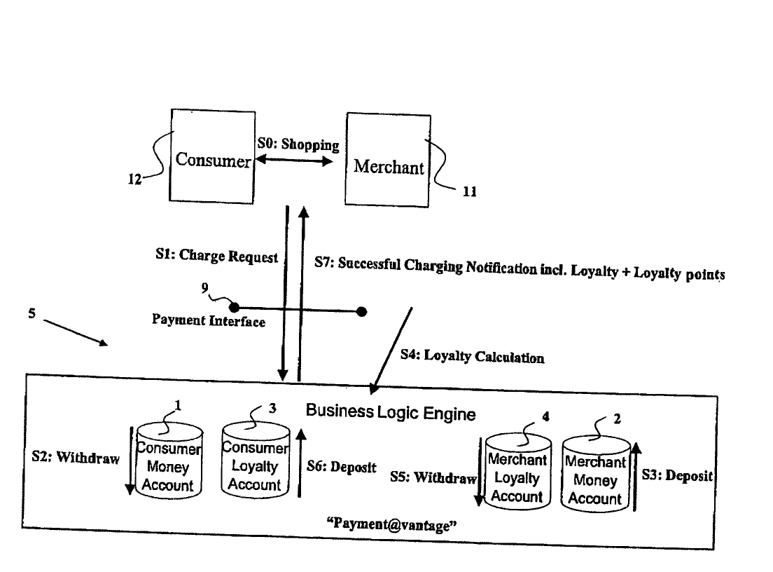

FIG. 1 shows an exemplary embodiment of the inventive account management system and the inventive method for transferring sums of money and bonus points between account memories in an account management system.

The figure shows a real time account management system 5 (“payment system”, “payment@vantage”) which manages accounts for consumers, merchants and payment service providers (PSPs). This payment system is operated by the payment service provider (PSPs). Specifically, the account management system 5 has a first account memory 1 (consumer money account) for storing information about monetary means belonging to a consumer, a second account memory 2 (merchant money account) for storing information about monetary means belonging to a merchant, a third account memory 3 (consumer loyalty account) for storing information about bonus points belonging to the consumer and a fourth account memory 4 (merchant loyalty account) for storing information about bonus points belonging to the merchant.

The account management system 5 (payment system) has a “payment interface” 9 which is used for sending payment requests to the payment system (S1: charge request). Such a payment request identifies both the merchant 11 and the consumer 12 which are involved in a purchase operation (S0: shopping). This payment interface is also available directly or indirectly to participants in an “open service architecture”.

The payment system implements the payment operation internally such that the sum requested by the merchant 11 is transferred from the consumer account 1 to the merchant account 2 (S2: withdraw, S3: deposit). As a result of this, the sum of points in the “loyalty program” (bonus points) which is to be estimated can be calculated directly (S4: loyalty calculation). The calculated points are then transferred from the specific account 4 belonging to the merchant/the merchant group to the specific loyalty account 3 belonging to the consumer (S5: withdrawal, S6: deposit) and are available for further use.

The use of points in the loyalty program is also possible within a payment operation. These points can be used as an alternative currency; the price of a product/service is then made up of a combination of a sum in a real currency and points. Points in a loyalty program can also be the only currency when paying, that is to say can be converted directly into a product/service and can conclude a business dealing.

What is claimed is:

1. An account management system, comprising:
a first account memory to store information about monetary means belonging to a consumer;
a second account memory to store information about monetary means belonging to a merchant;
a third account memory to store information about bonus points belonging to the consumer;
a fourth account memory to store information about bonus points belonging to the merchant; and
a control unit which, when a payment operation appears, prompts a sum of money to be transferred from the first account memory to the second account memory and prompts a number of bonus points to be transferred from the fourth account memory to the third account memory.

2. The account management system as claimed in claim 1, further comprising a payment interface which is configured to transfer payment requests to the account management system, with the merchant and the consumer being identified in the payment requests.

3. The account management system as claimed in claim 2, wherein the payment interface is accessible to participants in an open service architecture.

4. A method for transferring sums of money and bonus points between account memories in an account management system, the account management system, upon receiving a payment request, comprising:
transferring a sum of money requested by a merchant from a first account memory for storing information about monetary means belonging to a consumer to a second account memory for storing information about monetary means belonging to a merchant; and
transferring a number of bonus points from a fourth account memory for storing information about bonus points belonging to the merchant to a third account memory for storing information about bonus points belonging to the consumer.

5. The method as claimed in claim 4, wherein the number of bonus points is calculated in real time.

6. The method as claimed in claim 4, wherein the bonus points are used as an alternative currency within a payment operation.

7. The method as claimed in claim 4, wherein the number of bonus points is transferred following a transaction performed between the consumer and the merchant.

8. The method as claimed in claim 4, wherein the number of bonus points is calculated from the number of transactions between the consumer and the merchant.

9. The method as claimed in claim 4, wherein the number of bonus points is calculated from the level of transactions between the consumer and the merchant.
